(19) United States
(12) Patent Application Publication
(10) Pub. No.: US 2014/0049992 A1
(43) Pub. Date: Feb. 20, 2014

(54) Switching Power Supply

(71) Applicant: Asian Power Devices Inc., Taoyuan City (TW)

(72) Inventor: Po-Yang Lu, Taoyuan City (TW)

(73) Assignee: Asian Power Devices Inc., Taoyuan City (TW)

(21) Appl. No.: 13/903,410

(22) Filed: May 28, 2013

(30) Foreign Application Priority Data
Aug. 16, 2012 (TW) 101215879

(51) Int. Cl. H02M 1/12

(52) U.S. Cl. CPC H02M 1/12
USPC 363/44

(57) ABSTRACT

A switching power supply is suitable for transforming AC input voltage to DC output voltage. The switching power supply includes a transformer, a power circuit, an output circuit, a switching element, a control element, a shielding element and a metal element. The power circuit is coupled to the primary side of the transformer to receive AC input voltage. The output circuit is coupled to the secondary side of the transformer to provide DC output voltage to the load. The switching element is coupled to the primary side of the transformer, and is coupled to the primary side ground. The control element is coupled to the switching element to control the switch of the switching element. The shielding element is surrounded onto the transformer, and is coupled to the primary side ground. The metal element is leaned against the switching element, and is coupled to the primary side ground.

### RELATED APPLICATIONS

This application claims priority to Taiwan Application Serial Number TW101215879, filed Aug. 16, 2012, which is herein incorporated by reference.

### BACKGROUND

1. Field of Invention

The present invention relates to a switching power supply. More particularly, the present invention relates to a switching power supply which can effectively reduce the common mode noise (CMN).

2. Description of Related Art

FIG. 1 is a schematic diagram of a prior switching power supply. Referring to FIG. 1, the prior switching power supply 100 includes a transformer 110, a power circuit 120, a output circuit 130, a transistor Q₁, a pulse width modulation (PWM) 140 and a Y capacitor Cy.

The power circuit 120 and the output circuit 130 are respectively coupled to the primary side and the secondary side of the transformer 110, such that the power circuit 120 receives the AC input voltage to transmit the energy to the output circuit 130 via the transformer 110, such that DC output voltage is provided to the load 50.

The control circuit is composed of the transistor Q₁ and the pulse width modulation 140 to control the turn-on time of the transformer 110 to stable the magnitude of DC output voltage according to the different conditions of the load 50.

Inside the switching power supply 100, the common mode noise (CMN) must to be depressed below certain upper limit. The source of the common mode noise comes from switching the transistor Q₁ continuously to transmit the noise from the primary side to the secondary side via the parasitic capacitance inside the transformer 110.

By connecting the Y capacitor Cy between the primary side ground G₁ and the secondary side ground G₂, the common mode noise can be depressed by forming a loop via the Y capacitor Cy.

However, using the Y capacitor Cy will cause the issue of leakage current, such that the Y capacitor C_{y} is required not to be disposed in many consumer electronics products currently. Thus, how to depress the common mode noise has become an important challenge topic.

### SUMMARY

The present invention aims to provide a switching power supply to depress the common mode noise effectively without disposing the Y capacitor C_{y}.

In order to achieve the aforementioned object, a technical aspect of the present invention relates to a switching power supply suitable for transforming AC input voltage to DC output voltage and providing DC output voltage to a load. The switching power supply includes a transformer, a power circuit, an output circuit, a switching element, a control element, a shielding element and a metal element.

The power circuit is coupled to the primary side of the transformer to receive AC input voltage. The output circuit is coupled to the secondary side of the transformer to provide DC output voltage to the load. The switching element is coupled to the primary side of the transformer, and is coupled to the primary side ground. The control element is coupled to the switching element to control the switch of the switching element. The shielding element is surrounded onto the transformer, and is coupled to the primary side ground. The metal element is leaned against the switching element, and is coupled to the primary side ground.

In the switching power supply of the present invention, the shielding element may be the copper foil, and the metal element may be the heat sink. The common mode noise equivalently forms a virtual loop via the shielding element and the metal element to depress the common mode noise effectively to enhance the quality of the switching power supply of the present invention.

### BRIEF DESCRIPTION OF THE DRAWINGS

The following objectives, features, advantages and embodiments of the present invention can be more fully understood, with reference made to the accompanying drawings as follows:

FIG. 1 is a schematic diagram of a prior switching power supply;

FIG. 2A is a schematic diagram of the switching power supply according to one embodiment of the present invention;

FIG. 2B and FIG. 2C are respectively a perspective assemble diagram and a perspective exploded diagram of the transformer and the shielding element of the switching power supply of the FIG. 2A;

FIG. 2D and FIG. 2E are respectively a perspective assemble diagram and a perspective exploded diagram of the switching element and the metal element of the switching power supply of the FIG. 2A;

FIG. 3A is an experimental data diagram of measuring the signal of the prior switching power supply; and

FIG. 3B is an experimental data diagram of measuring the signal of the switching power supply according to one embodiment of the present invention.

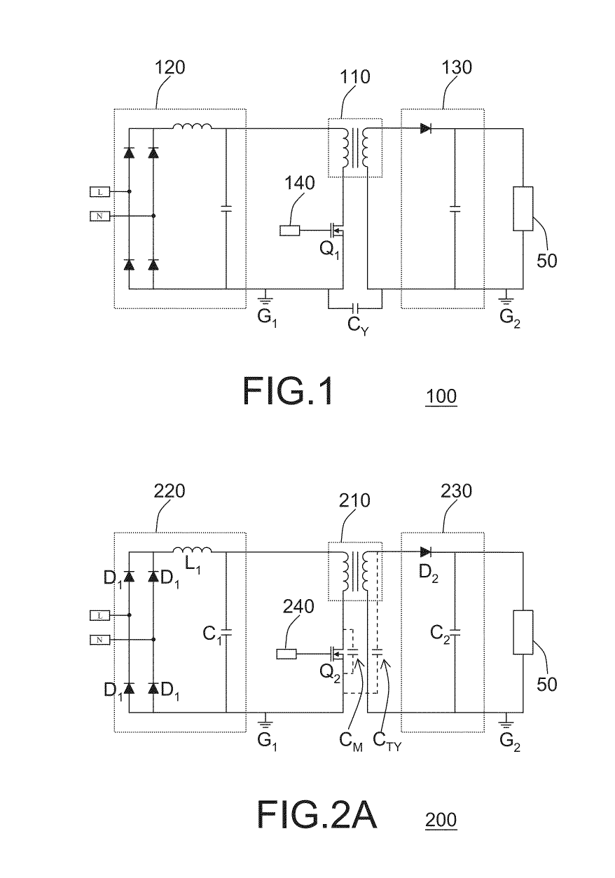

### DETAILED DESCRIPTION

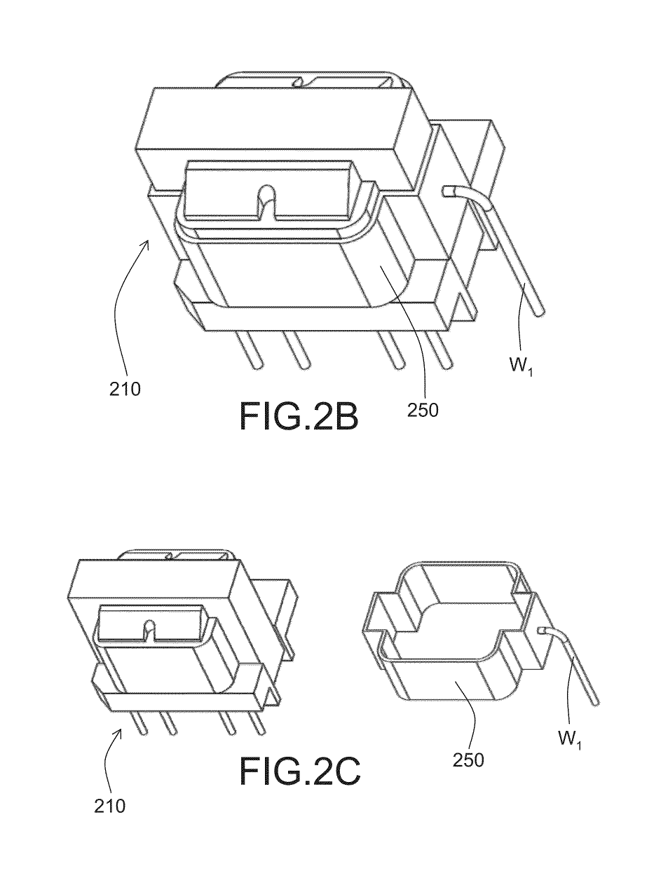

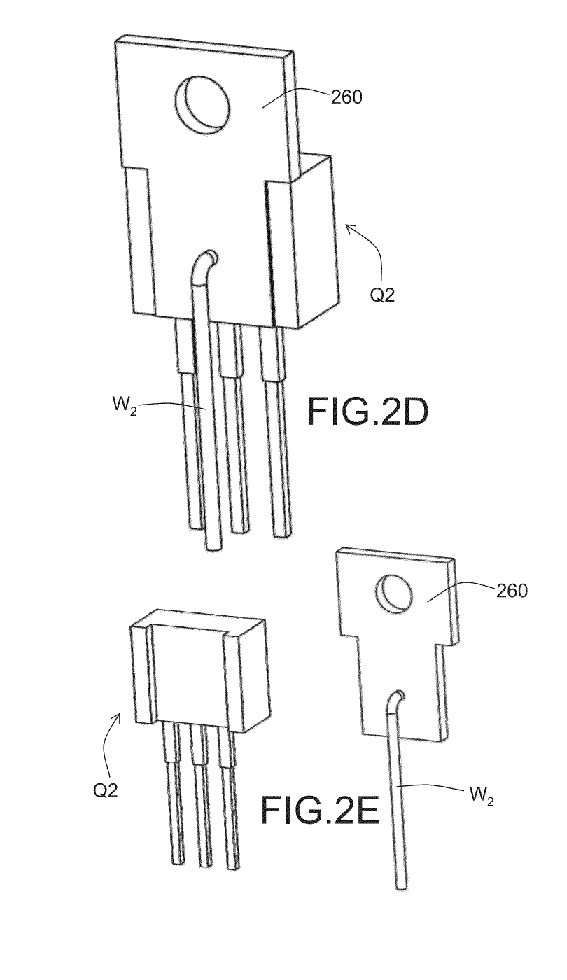

FIG. 2A is a schematic diagram of the switching power supply according to one embodiment of the present invention. FIG. 2B and FIG. 2C are respectively a perspective assemble diagram and a perspective exploded diagram of the transformer and the shielding element of the switching power supply of the FIG. 2A. FIG. 2D and FIG. 2E are respectively a perspective assemble diagram and a perspective exploded diagram of the switching element and the metal element of the switching power supply of the FIG. 2A.

Referring to FIG. 2A to 2E, the switching power supply 200 of the present invention includes a transformer 210, a power circuit 220, an output circuit 230, a switching element Q₂, a control element 240, a shielding element 250 and a metal element 260.

The power circuit 220 is coupled to the primary side of the transformer 210 to receive AC input voltage. In this embodiment, the power circuit 220 can include a rectifier circuit with four diodes D₁ and a filter circuit with a capacitor C₁ and an inductor L₁ to initially transform AC power to DC power and provide DC power to the transformer 210.

The output circuit 230 is coupled to the secondary side of the transformer 210 to provide DC output voltage to the load 50. In this embodiment, the output circuit 230, for example, is the fly-back topology, and is composed of the diode D₂ and the capacitor C₂. However, the present invention is not limited to the type of the switching power supply 200. For example, the output circuit 230 can also be the forward topology or the push-pull topology.

The control circuit is composed of the switching element Q₂ and the control element 240, wherein the switching element Q₂, for example, is the transistor, and the drain, source and gate of the switching element Q₂ are respectively coupled to the primary side of the transformer 210, the primary side ground G₁ and the control element 240. The control element 240, for example, is the pulse width modulation to stable the magnitude of DC output voltage by adjusting the turn-on time of the switching element Q₂.

Referring to FIG. 2A to 2E again, the shielding element 250 is surrounded onto the transformer 210, and is coupled to the primary side ground G₁ to form the equivalent virtual capacitor C_{TY} (as shown in FIG. 2A). In this embodiment, the shielding element 250, for example, is originally the flat copper foil. After the shielding element 250 is surrounded onto the coil peripheral of the transformer 210, the shape of the shielding element 250 will be changed depending on the peripheral of the transformer 210.

After the shielding element 250 is surrounded onto the transformer 210 around one circle, the tail of the shielding element 250 is connected to the head of the shielding element 250, and the wire W₁ soldered on the shielding element 250 is connected to the primary side ground G₁, such that the shielding element 250 is coupled to the primary side ground G₁.

It is worth emphasizing that the spirit of the present invention is to surround the shielding element 250 onto the transformer 210, such that the gap between the shielding element 250 and the transformer 210 can form the virtual capacitor C_{TY}. Thus, the present invention is not limit to the method and the number of turns of surrounding the shielding element 250 onto the transformer 210, and is also not limit to the method of coupling the shielding element 250 to the primary side ground G₁. For example, the wire W1 can also be soldered to the pin of the transformer 210, and then the pin of the transformer 210 can be soldered on the pad of the primary side ground G1 of the printed circuit board (PCB).

Besides, in this embodiment, although the shielding element 250 is surrounded onto the bobbin periphery of the transformer 210, but the shielding element 250 can also be surrounded onto the periphery of the welding set depending on the convenience of design.

Referring to FIG. 2A to 2E again, the metal element 260 is leaned against the switching element Q₂, and is coupled to the primary side ground G1 to form the equivalent virtual capacitor C_{M} (as shown in FIG. 2A). In this embodiment, the metal element 260, for example, is the heat sink, and is leaned against the main body of the switching element Q₂ by engagement. For achieving better cooling effect, the thermal grease can be coated between the metal element 260 and the switching element Q₂ to enhance uniform contact.

The wire W₂ can be soldered on the metal element 260, and is connected to the primary side ground G₁, but the present invention is not limit to the method of coupling the metal element 260 to the primary side ground G₁. For example, the pins extended downward can be disposed in the metal element 260, and the pins of the metal element 260 can be soldered on the pad of the primary side ground G₁ of the printed circuit board to make the metal element 260 to connect the primary side ground G₁ directly.

It is worth emphasizing that the spirit of the present invention is to lean the metal element 260 against the switching element Q2, such that the partial plastic shell of the switching element Q2 can form the virtual capacitor C_{M}. Generally speaking, the switching element Q2 will need the heat sink for the generation of the waste heat, and the present invention uses the heat sink to be the metal element 260, but the present invention is not limited to the type of the metal element 260.

By the virtual capacitor C_{TY} and capacitor C_{M} mentioned above, the common mode noise can form a loop via the virtual capacitor C_{TY} and capacitor C_{M} to depress the common mode noise effectively. Thus, without disposing the Y capacitor for the leakage current issue, the present invention can further depress the common mode noise to enhance the quality of the switching power supply 200.

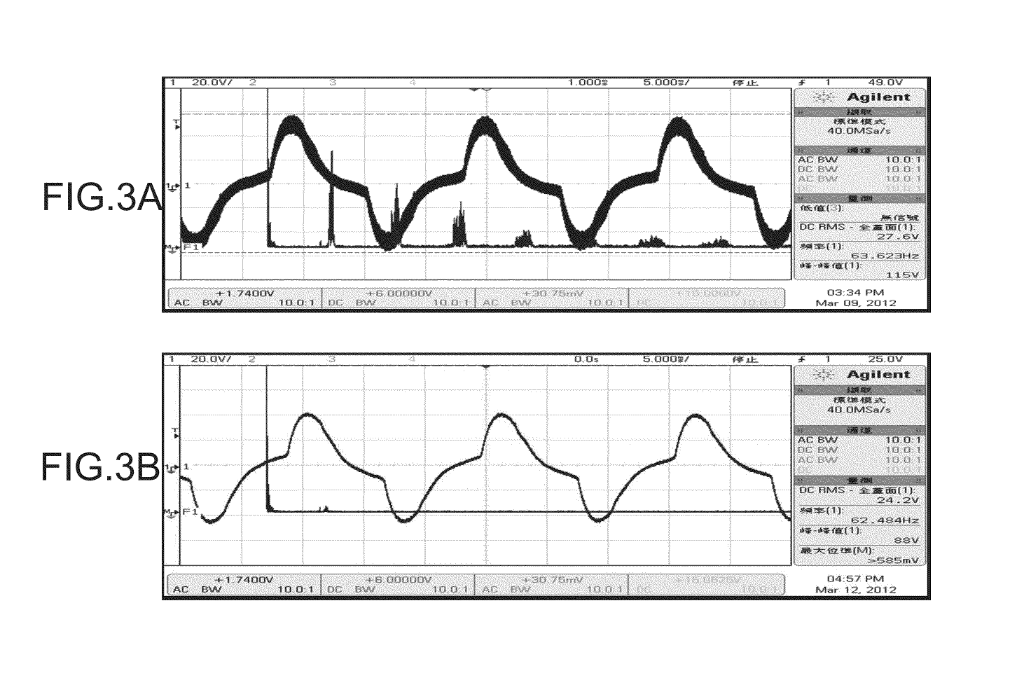

FIG. 3A is an experimental data diagram of measuring the signal of the prior switching power supply, and FIG. 3B is an experimental data diagram of measuring the signal of the switching power supply according to one embodiment of the present invention, wherein there is no Y capacitor disposed in both switching power supplies. Referring to FIG. 3A and 3B, the noise of the switching power supply of the present invention is significantly lower than the noise of the prior switching power supply, thus the virtual capacitor C_{TY} and capacitor C_{M} structure indeed can effectively depress the common mode noise.

It is worth emphasizing that the present invention is not limited to exclude the configuration of the Y capacitor. For example, the present invention also can couple the Y capacitor between the primary side ground G₁ and the secondary side ground G₂ (not shown in the figure), to increase the leakage current, but further depress the common mode noise.

In summary, the switching power supply of the present invention at least has the following advantage:

1. The present invention uses the combination of the shielding element and the transformer, and the combination of the metal element and the switching element to form the virtual capacitor to depress the common mode noise effectively to enhance the electrical quality of the switching power supply.

2. The common mode noise can be depressed with or without disposing the Y capacitor, such that the designer is more convenient in design.

Although the present invention has been described with reference to the above embodiments, these embodiments are not intended to limit the present invention. It will be apparent to those skilled in the art that various modifications and variations can be made without departing from the scope or spirit of the present invention. Therefore, the scope of the present invention shall be defined by the appended claims.

What is claimed is:

1. A switching power supply suitable for transforming AC input voltage to DC output voltage and providing DC output voltage to a load, the switching power supply comprising:
a transformer;
a power circuit coupled to the primary side of the transformer to receive AC input voltage;
an output circuit coupled to the secondary side of the transformer to provide DC output voltage to the load;
a switching element coupled to the primary side of the transformer and a primary side ground;
a control element coupled to the switching element to control the switch of the switching element;
a shielding element surrounded onto the transformer and coupled to the primary side ground; and
a metal element leaned against the switching element and coupled to the primary side ground.

2. The switching power supply of claim 1, wherein the shielding element is the copper foil.

3. The switching power supply of claim 1, wherein the switching element is the transistor, and the metal element is the heat sink.

4. The switching power supply of claim 1, wherein there is no Y capacitor disposed in the switching power supply.

5. The switching power supply of claim 4, wherein the shielding element is the copper foil.

6. The switching power supply of claim 4, wherein the switching element is the transistor, and the metal element is the heat sink.
